(19) United States
(12) Patent Application Publication
(10) Pub. No.: US 2008/0012985 A1
(43) Pub. Date: Jan. 17, 2008

(54) System and method for synchronizing video frames and audio frames

(75) Inventors: Ming-Kuei Yu, Bade City (TW); Hsien-Ming Tsai, Jiali Township (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Quanta Computer Inc.

(21) Appl. No.: 11/704,830

(22) Filed: Feb. 8, 2007

(30) Foreign Application Priority Data
Jul. 12, 2006 (TW) 095125389

(51) Int. Cl. H04N 5/926

(52) U.S. Cl. 348/515; 348/E09.034

(57) ABSTRACT

The invention discloses a method for synchronizing video frames and audio frames in an audio/video player system. The method includes steps of: (a) reading a predetermined audio playing time of a audio frame and retrieving an actual audio playing time of the audio frame; (b) calculating a synchronization offset time according to the predetermined audio playing time and the actual audio playing time of the audio frame; (c) calculating an adjusted video playing time for a video frame according to the synchronization offset time, a predetermined video playing time of the video frame, and a predefined video rendering offset time; and (d) selectively playing video frames according to the adjusted video playing time and current time. Accordingly, the video frames and the audio frames can both be synchronized at the same time.

### BACKGROUND OF THE INVENTION

1. Field of the Invention

The invention relates to an audio/video player system, and more particularly to an audio/video player system and method for synchronizing video frames and audio frames.

2. Description of the Prior Art

An audio/video player system should be able to play an audio/video file stored in a storage device. If the audio/video data of the audio/video file have been encoded, the audio/video player system should be able to decode the audio/video data by using proper audio/video decoders and then to play the decoded audio/video data. It is a big challenge for an audio/video player system to synchronize video data and audio data.

Typically, video data and audio data are synchronized by comparing the predetermined playing times of an audio frame and a video frame with the current time, calculating according to above comparison, and then playing the video frame and audio frame at the proper time. Generally, the playing time of an audio frame is not allowed to be more than 15 milliseconds earlier or more than 45 milliseconds later than the playing time of a video frame. If the condition is not satisfied, the viewer will apparently feel that the audio and video frames are asynchronous.

A conventional audio/video player system reads video frames and audio frames from a storage device and plays the video frames and audio frames by using a single integrated process, and the process is capable of maintaining the synchronization between the video frames and audio frames. However, with the progress of multitask and multithread computing, most computer users would like to watch digital video and perform other programs or functions at the same time. Accordingly, the aforesaid single process playing technology is fading away and is being replaced by the technology that separates video data from audio data and decodes, processes, and plays the video data and audio data respectively, so as to comply with multitask requirement.

Nevertheless, such function leads to additional multimedia synchronization problems. Especially when the technology separates video data from audio data and decodes, processes and plays the video data and audio data respectively, the video data and audio data will easily be played asynchronously.

There are methods in accordance with the prior art for synchronizing audio frames and video frames, such as U.S. Pat. No. 6,510,279 (hereinafter '279 patent), U.S. Pat. No. 6,262,776 (hereinafter '776 patent), and U.S. Pat. No. 6,016,166 (hereinafter '166 patent), but these prior arts can not solve the following problems.

Generally, there are two reasons that lead to asynchronous playing of video data and audio data: (1) a display delay time caused when a monitor plays a video frame; (2) inaccuracy of output sample rate of the audio output device. Detailed descriptions are as following.

Referring to FIG. 1, FIG. 1 shows the cause of the display delay time when a monitor plays video frames. As shown in FIG. 1, when the monitor plays a video frame V (V₀, V₁ or V₂) at a time T_{V} (T_{V0}, T_{V1} or T_{V2}), the actual time at which the video frame V (V₀, V₁ or V₂) is really displayed on the screen of the monitor is T_{V}′ (T_{V0}′, T_{V1}′ or T_{V2}′). In other words, the monitor needs a period of time to process a video frame and then to display the video frame on the screen, wherein the time difference is the display delay time D_{LCD} as shown in FIG. 1.

Referring to FIG. 2A and FIG. 2B, FIG. 2A shows the playing of audio frames under ideal conditions; FIG. 2B shows the playing of audio frames under actual conditions. As shown in FIG. 2A and FIG. 2B, t_{An}(n=1, 2, . . . ) is the predetermined playing time of the audio frame Aₙ recorded in the file, and T_{An} is the actual playing time at which the audio frame Aₙ is played by the audio output device. Under ideal conditions, when the audio frame Aₙ is being played, the predetermined playing time t_{An} recorded in the file equals the actual playing time T_{An}, as shown in FIG. 2A. However, because of the inaccuracy of output sample rate, after the audio output device plays for a while, the predetermined playing time t_{An} recorded in the file will be different from the actual playing time T_{An}, as shown in FIG. 2B.

Take AMR as an example, each AMR audio frame contains 160 audio samples, and the output sample rate is 8000 Hz. However, because the clock utilized by the audio output device is not accurate, the actual output sample rate may be 7999 Hz, and the audio samples normally played per second reduce from 8000 to 7999. Therefore, after playing for 1000 seconds, the number of the audio samples actually played is 1000*(8000−7999)=1000 less than the number of the audio samples that should be played theoretically. Accordingly, after 1000 seconds, the difference between the predetermined playing time t_{An} of audio frame t_{An} and the actual playing time T_{An} will be 1000*(1/8000*100)=125 microseconds. According to the aforesaid asynchronous condition of video data and audio data, the viewer will perceive that the video data and audio data are asynchronous.

In prior art, neither the '279 patent nor the '166 patent made improvement in the display delay time and the inaccuracy of audio output sample rate. Though the '766 patent improved the display delay time, it did not consider the inaccuracy of the audio output sample rate.

Consequently, a scope of the invention is to provide an audio/video player system and method for solving the above problems.

### SUMMARY OF THE INVENTION

A scope of the invention is to provide an audio/video player system and method for synchronizing video frames and audio frames, so as to enhance the audio/video playing quality.

A preferred embodiment according to the invention is an audio/video player system including a memory, a processor, an audio decoder, a video decoder, a bus, a storage interface, a storage device, an audio output interface, an audio output device, a video output interface, and a video output device.

In the above embodiment, the memory is used for storing a software program code and for storing audio frames and video frames temporarily. The bus is used for communication among each interface, the memory, the processor, the audio decoder, and the video decoder. The storage device is used for storing a compressed audio/video file that includes compressed data of audio frames, predetermined audio playing time information, compressed data of video frames, and predetermined video playing time; the storage device also uses the storage interface to communicate with other components on the bus. The audio decoder and the video decoder are used for decoding the encoded audio frames and video frames. The audio output interface and the video output interface are used for sending the decoded audio frames and video frames to the audio output device and the video output device for playing. The processor is used for performing the software program code stored in the memory and for controlling all the components to play audio data and video data at the proper time.

The processor accesses an encoded audio frame and an encoded video frame from the storage device via the storage interface and stores them in the memory temporarily; it also simultaneously retrieves a predetermined audio playing time and a predetermined video playing time from the audio frame and the video frame and controls the audio decoder and the video decoder to decode the audio frame and video frame temporarily stored in the memory. Afterward, the processor sends the decoded audio frame and video frame respectively to the audio output device and the video output device for display via the audio output interface and the video output interface, and it then retrieves an actual audio playing time. Then, the processor calculates a synchronization offset time according to the predetermined audio playing time and the actual playing time of the audio frame. Consequently, the processor calculates an adjusted video playing time of the video frame according to the synchronization offset time, the predetermined video playing time, and the display delay time. Furthermore, according to the adjusted video playing time and the current time, the processor selectively sends the video frame to the video output device for playing. Thereby, the video frames and audio frames are synchronized.

Accordingly, the audio/video player system and method of the invention not only consider the display delay time owing to the monitor but also the inaccuracy of audio output sample rate, so as to synchronize video frames and audio frames and to enhance the audio/video playing quality.

The advantage and spirit of the invention may be understood by the following recitations together with the appended drawings.

### BRIEF DESCRIPTION OF THE APPENDED DRAWINGS

FIG. 1 shows the cause of the display delay time when a monitor plays video frames.

FIG. 2A shows the playing of audio frames under ideal condition.

FIG. 2B shows the playing of audio frames under actual condition.

FIG. 3 shows a function block diagram of an audio/video player system of the first preferred embodiment according to the invention.

FIG. 4 shows the playing of the video frames of the first preferred embodiment according to the invention.

FIG. 5 shows a flowchart of an audio/video player method of the first preferred embodiment according to the invention.

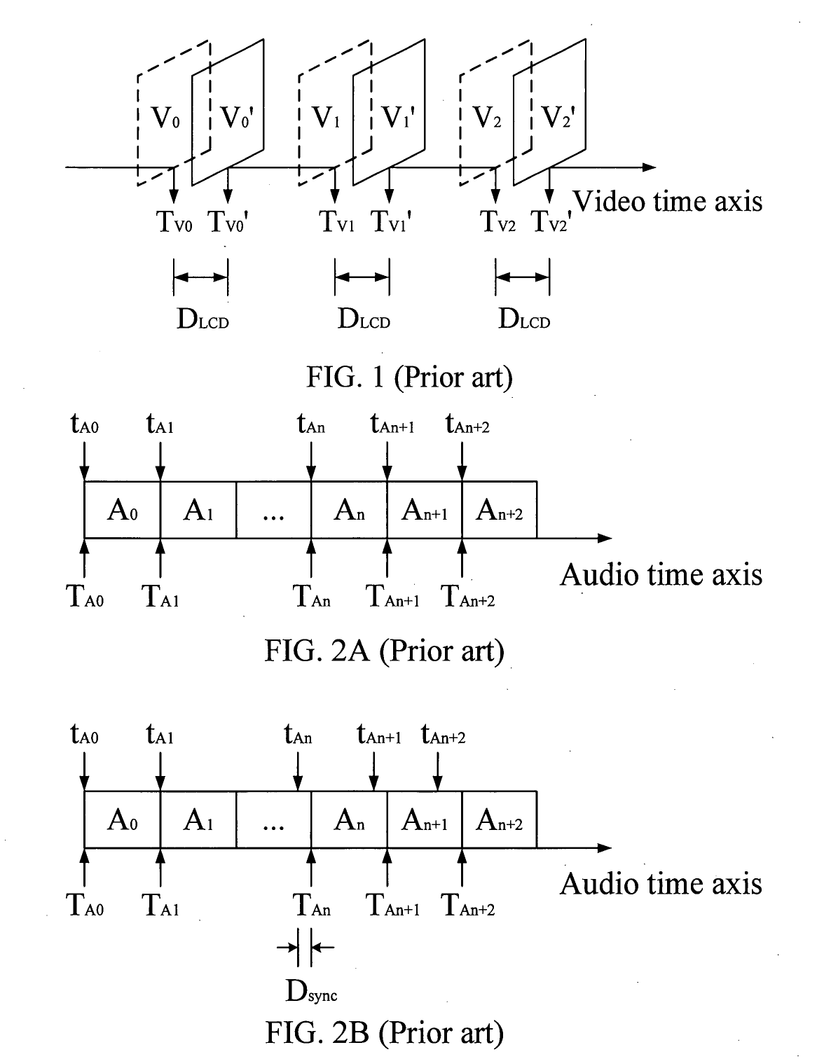

### DETAILED DESCRIPTION OF THE INVENTION

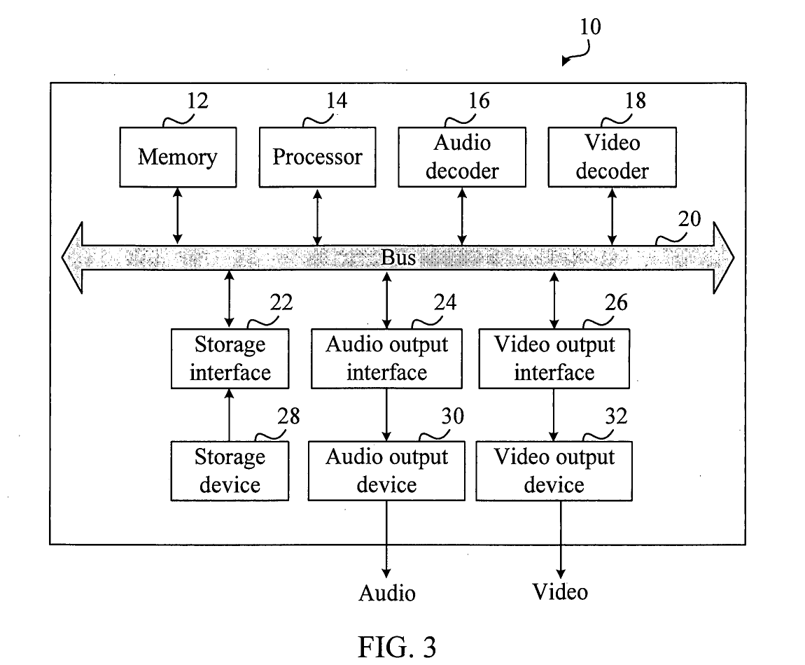

Referring to FIG. 3, FIG. 3 shows a functional block diagram of an audio/video player system 10 of a first preferred embodiment according to the invention. The audio/video player system 10 is used for synchronizing all video frames and audio frames. As shown in FIG. 3, the audio/video player system 10 includes a memory 12, a processor 14, an audio decoder 16, a video decoder 18, a bus 20, a storage interface 22, a storage device 28, an audio output interface 24, an audio output device 30, a video output interface 26 and a video output device 32. The audio output device 30 can be a speaker or the like, and the video output device 32 can be a liquid crystal display (LCD) or the like. It should be noticed that a processor 14, a memory 12, an audio decoder 16, a video decoder 18, a storage interface 22, an audio output interface 24, a video output interface 26 and a bus 20 can be integrated into a system on a chip (SoC). If the performance of the processor 14 is high, the processor 14 can decode the compressed audio frames instead of using the audio decoder 12. If the performance of the processor 14 is high enough, the processor 14 can even decode the compressed video frames instead of using the video decoder 18.

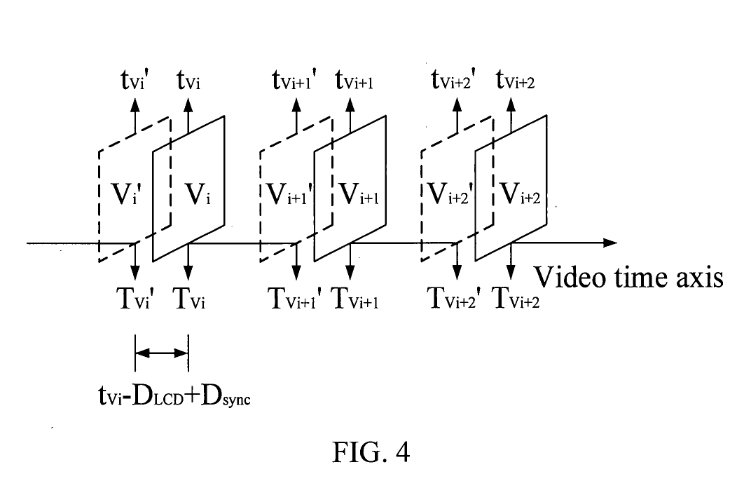

Referring to FIG. 2B and FIG. 4, FIG. 4 shows the playing of the video frames of the first preferred embodiment according to the invention. In the embodiment, the processor 14 is used for reading a compressed audio frame and its predetermined playing time or for reading a video frame and its predetermined playing time from the storage device 28. If the processor 14 first reads a compressed audio frame Aₙ and its predetermined playing time t_{An}, the processor 14 uses the audio decoder 16 to decode the audio frame Aₙ and sends the audio frame Aₙ via the audio interface 24 to the audio output device 30 for playing; it also simultaneously retrieves an actual audio playing time T_{An} of the audio frame Aₙ. As shown in FIG. 2B, the processor 14 calculates a synchronization offset time. D_{sync}(t_{An}−T_{An}) according to the predetermined audio playing time t_{An} and the actual playing time T_{An} of the audio frame Aₙ. If the processor 14 first reads a compressed video frame Vᵢ(i=1, 2, . . . ) and its predetermined playing time t_{Vi}, the processor 14 calculates an adjusted video playing time t_{adj}(t_{Vi}−D_{LCD}+D_{sync}) of the video frame Vᵢ according to the synchronization offset time D_{sync}, the predetermined video playing time t_{Vi} and the display delay time D_{LCD}, as shown in FIG. 4. According to the adjusted video playing time t_{adj} and a current time T, the processor 14 selectively sends the video frame Vᵢ via the video output interface 26 to the video output device 32 for playing. Thereby, video frames and audio frames are synchronized. In the embodiment, the display delay time D_{LCD} is a process time when a video output device plays a video frame. The current time T is the current display time of the system.

In the aforesaid embodiment, the processor 14 selectively plays video frames according to an advanced delay and drop policy. If the adjusted video playing time t_{adj} is after the current time T, i.e. the current system display time has not reached the adjusted video playing time t_{adj} yet, the processor 14 will delay the playing of the video frame Vᵢ until the current time T reaches the adjusted video playing time t_{adj}. If the adjusted video playing time t_{adj} is prior to the current time T, i.e. the current system display time has already exceeded the adjusted video playing time t_{adj}, the processor 14 will further judge whether the difference between the adjusted video playing time t_{adj} and the current time T is larger than a threshold. If the difference between the adjusted video playing time and the current time is larger than the threshold, the processor 14 will drop the video frame Vᵢ, i.e. the video frame Vᵢ will not be played; otherwise, the processor 14 will play the video frame Vᵢ at the current time T. Accordingly, not only video and audio frames can be played synchronously, but the decoded video frames can be played to the utmost as long as the synchronization is not affected, so as to enhance the video playing quality. In this embodiment, the threshold can set according to different requirements. In an example, the threshold can be set as t_{Vi}−2D_{LCD}.

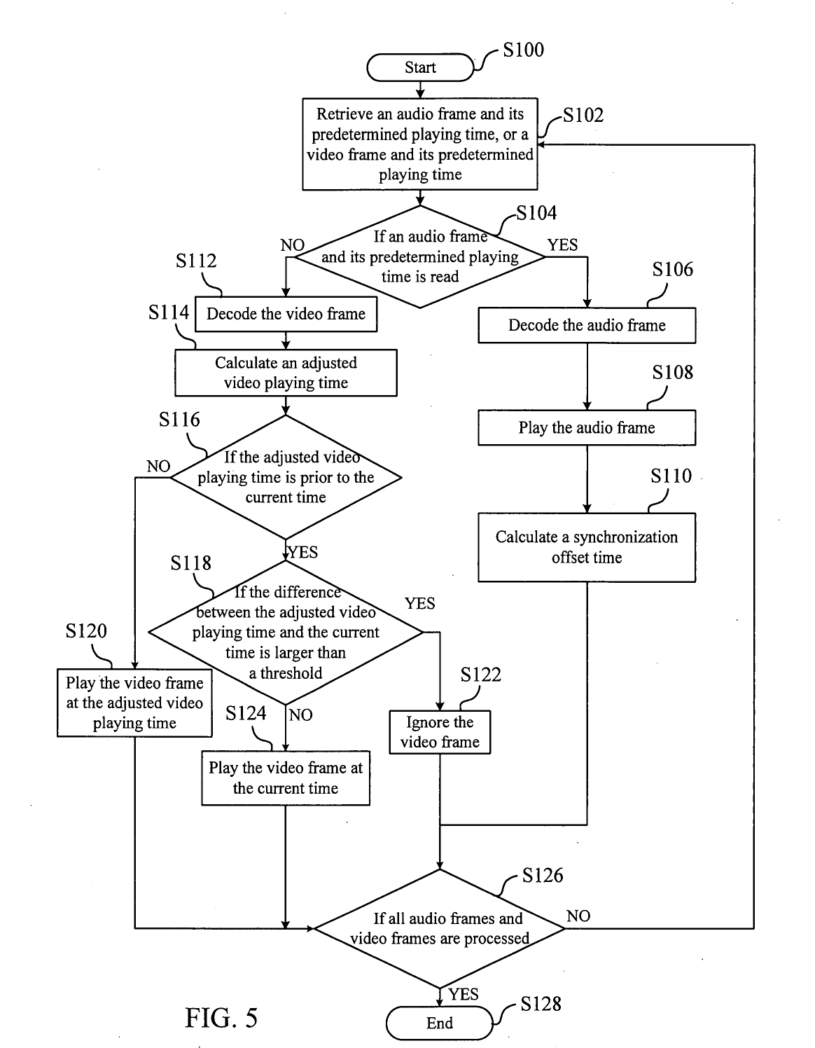

Referring to FIG. 5, FIG. 5 shows a flowchart of an audio/video player method of the first preferred embodiment according to the invention. According to the embodiment, the method of the invention is used for synchronizing video frames and audio frames. The method includes the following steps.

Step S100: start.

Step S102: read audio/video data stored in the storage device, and retrieve an audio frame and its predetermined audio playing time or a video frame and its predetermined video playing time.

Step S104: if an audio frame is read in step S102, then perform step S106, else perform step S112.

Step S106: decode the compressed audio frame.

Step S108: send the decoded audio frame via the audio output interface to the audio output device for playing.

Step S110: calculate a synchronization offset time according to the actual audio playing time and a predetermined audio playing time.

Step S112: decode the video frame.

Step S114: calculate an adjusted video playing time according to the synchronization offset time, a predetermined video playing time of the video frame and a display delay time.

Step S116: judge whether the adjusted video playing time is prior to the current time, if it is NO, perform step S120, if it is YES, perform step S118.

Step S118: judge whether the difference between the adjusted video playing time and the current time is larger than a threshold; if it is YES, perform step S122, and if it is NO, perform step S124.

Step S120: delayingly play the video frame at the adjusted video playing time.

Step S122: ignore the video frame.

Step S124: play the video frame at the current time.

Step S126: check whether all audio frames and video frames are processed, if it is YES, perform step S128, if it is NO, perform step S102.

Step S128: end.

Compared to the prior art, the audio/video player system and method of the invention not only consider the display delay time due to the monitor but also the inaccuracy of the audio output sample rate, so as to synchronize video frames and audio frames and to enhance the audio/video playing quality. Moreover, by using the advanced delay and drop policy, not only video and audio frames can be played synchronously, but the decoded video frames can be played to the utmost as long as the synchronization is not affected, so as to enhance the video playing quality.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for synchronizing video frames and audio frames in an audio/video player system, the method comprising steps of:
(a) reading an audio frame among the audio frames and retrieving a predetermined audio playing time, decoding the audio frame, playing the audio frame and retrieving an actual audio playing time;
(b) calculating a synchronization offset time according to the predetermined audio playing time and the actual audio playing time of the audio frame;
(c) reading a video frame among the video frames and retrieving a predetermined video playing time;
(d) calculating an adjusted video playing time corresponding to the video frame according to the synchronization offset time, the predetermined video playing time and a display delay time; and
(e) decoding the video frame and playing the video frame according to the adjusted video playing time.

2. The method of claim 1, wherein step (e) comprises steps of:
(e1) judging whether the adjusted video playing time is prior to a current time, if NO, performing step (e2), if YES, performing step (e3);
(e2) delayingly playing the video frame at the adjusted video playing time; and
(e3) judging whether the difference between the adjusted video playing time and the current time is larger than a threshold, if YES, ignoring the video frame, if NO, playing the video frame at the current time.

3. An audio/video player system for synchronizing video frames and audio frames, the player system comprising:
a memory for storing a software program code and temporarily storing the video frames and the audio frames;
an audio decoder for decoding the audio frames;
a video decoder for decoding the video frames;
a storage device for storing the audio frames, a predetermined audio playing time information, the video frames and a predetermined video playing time information;
a storage interface for accessing data stored in the storage device;
an audio output device for playing the audio frames;
an audio output interface for outputting the audio frames to the audio output device;
a video output device for playing the video frames;
a video output interface for outputting the video frames to the video output device;
a bus for providing communication among each interface, the memory, a processor, the audio decoder and the video decoder; and
the processor for performing the software program code stored in the memory, the software program code comprising steps of:
(a) controlling the storage interface to read an audio frame among the audio frames and retrieving a predetermined audio playing time, controlling the audio decoder to decode the audio frame, controlling the audio output interface to play the audio frame and retrieving an actual audio playing time;
(b) calculating a synchronization offset time according to the predetermined audio playing time and the actual audio playing time of the audio frame;
(c) controlling the storage interface to read a video frame among the video frames and retrieving a predetermined video playing time;
(d) calculating an adjusted video playing time corresponding to the video frame according to the synchronization offset time, the predetermined video playing time, and a display delay time; and
(e) controlling the video decoder to decode the video frame and controlling the video output interface to play the video frame according to the adjusted video playing time.

4. The player system of claim 3, wherein step (e) performed by the processor comprises steps of:
(e1) judging whether the adjusted video playing time is prior to a current time, if NO, performing step (e2), if YES, performing step (e3);
(e2) delayingly playing the video frame at the adjusted video playing time; and
(e3) judging whether the difference between the adjusted video playing time and the current time is larger than a threshold, if YES, ignoring the video frame, if NO, playing the video frame at the current time.

5. The player system of claim 3, wherein the processor, the memory, the audio decoder, the video decoder, the storage interface, the audio output interface, the video output interface, and the bus are integrated into a system on a chip.

6. The player system of claim 3, wherein the processor is capable of decoding the audio frames instead of the audio decoder.

7. The player system of claim 3, wherein the processor is capable of decoding the video frames instead of the video decoder.
